(19) United States
(12) Patent Application Publication
(10) Pub. No.: US 2005/0198361 A1
(43) Pub. Date: Sep. 8, 2005

(54) Method and apparatus for meeting a given content throughput using at least one memory channel

(76) Inventors: Prashant R. Chandra, Sunnyvale, CA (US); Uday Naik, Fremont, CA (US); Alok Kumar, Santa Clara, CA (US); Ameya Varde, Santa Clara, CA (US); Donald Hooper, Shrewsbury, MA (US); Debra Bernstein, Sudbury, MA (US); Myles J. Wilde, Charlestown, MA (US); Mark Rosenbluth, Uxbridge, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/748,780

(22) Filed: Dec. 29, 2003

(51) Int. Cl. G06F 15/16; G06F 15/173

(52) U.S. Cl. 709/235; 709/224

(57) ABSTRACT

A method and apparatus for meeting a given content throughput using at least one memory channel is generally described. In accordance with one example embodiment of the invention, a method to meet a given content throughput using at least one memory channel comprising, comparing the size of at least a portion of received content to a capacity of a single contiguous location within at least one memory channel to meet a given throughput and determining whether to distribute the at least portion of received content across the at least one memory channel, based at least in part, on the comparison.

### TECHNICAL FIELD

Embodiments of the present invention generally relate to the field of electronic systems, and more particularly, to a method and apparatus for meeting a given content throughput using at least one memory channel.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a block diagram of an electronic system incorporating the teachings of the present invention, according to but one example embodiment of the invention;

FIG. 2 is an architectural diagram of a routing manager, according to one example embodiment of the present invention;

FIG. 3 is a flow chart of an example method of meeting a given content throughput in accordance with the teachings of the present invention, according to one example embodiment;

FIG. 4 is an architectural diagram of an access manager, according to one example embodiment of the present invention; and

FIG. 5 is a flow chart of an example method of accessing at least a portion of received content distributed across at least one memory channel, combining, and presenting the at least portion of received content according to one example embodiment.

### DETAILED DESCRIPTION

Embodiments of the present invention are generally directed to a method and apparatus for meeting a given content throughput using at least one memory channel. In accordance with one example embodiment, a routing manager is introduced herein. As described more fully below, the innovative routing manager is operable to compare the size of at least a portion of received content, to the capacity of a single contiguous location within at least one memory channel to meet a given throughput, e.g. communication channel speed, and determine whether to distribute the at least portion of received content across the at least one memory channel based, at least in part, on the comparison.

The routing manager may make its determination either statically, i.e. at time of start-up, or dynamically, i.e. during run-time, and based on that determination distribute the at least portion of received content across at least one memory channel.

In the context of at least one embodiment, at least a portion of received content may be stored in at least one memory array or “memory channel,” which is communicatively coupled to an electronic system. If content is for example, a data packet, a given “throughput” for processing the data packet may be required. Throughput may be defined as the amount of data or content, processed in a specified amount of time, although the invention is not limited in this regard.

In the following description, for purposes of explanation, numerous specific details are set forth in order to provide a thorough understanding of the invention. It will be apparent, however, to one skilled in the art, that the invention can be practiced without these specific details. In other instances, structures and devices are shown in block diagram form in order to avoid obscuring the invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily referring to the same embodiment.

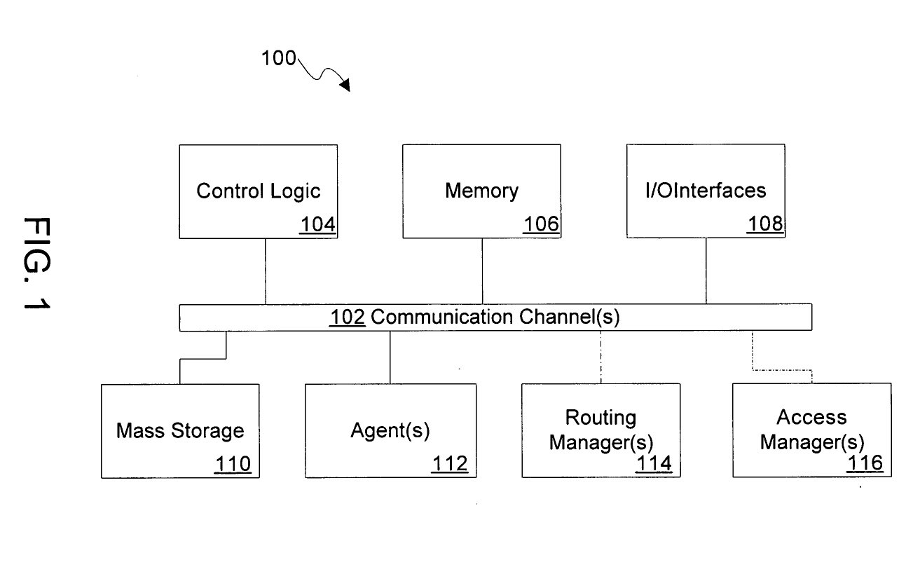

FIG. 1 is a block diagram of an electronic system 100 incorporating the teachings of the present invention, according to but one example embodiment. Electronic system 100 may be, for example, a computer, a Personal Digital Assistant (PDA), a set-top box, a communications device (e.g., cellular telephone, wireless communicator, etc.), or any other electronic system.

In accordance with the illustrated example implementation of FIG. 1, electronic system 100 is depicted comprising communication channel(s) 102, control logic 104, memory 106, I/O interfaces 108, mass storage 110, agent(s) 112, routing manager(s) 114, and access manager(s) 116 each coupled as depicted.

In accordance with one example embodiment of the present invention, control logic 104 may process information and execute instructions to implement the various functions/features offered by electronic system 100. Electronic system 100 further includes memory 106 to store information and instructions to be executed by control logic 104 in support of the functions/features offered by electronic system 100. In this regard, memory 106 may also be used to store temporary variables or other intermediate information during execution of instructions by control logic 104. As used herein, memory 106 may well include one or more of random access memory (RAM), read-only memory (ROM), flash, or other static or dynamic storage media.

In one example embodiment, routing manager(s) 114 and/or access manager(s) 116 are communicatively coupled to memory 106, which may include at least one memory channel. When content, e.g. a data packet, is received by system 100 at least a portion of the received content may be stored in at least one memory channel of memory 106. The portion of received content may be descriptor information defined as “packet meta data,” although the invention is not limited in this regard. Furthermore, as explained in more detail below, the portion of received content may also include a packet handle to assist in the accessing of distributed portions of received content, although the invention is not limited in this regard.

In an example implementation, routing manager(s) 114, to ensure that a given throughput is met, may compare the size of packet meta data to the capacity of a single contiguous location within at least one memory channel of memory 106 to meet a given throughput, and then determine based, at least in part, on that comparison, whether the packet meta data is to be selectively distributed across at least one memory channel of memory 106. Routing manager(s) 114 may then distribute the packet meta data to at least one memory channel of memory 106 based, at least in part, on that determination.

In an example embodiment, a given throughput of communication channel speed may be the ability to process at least a portion of received content in a way that does not degrade the throughput of a communication channel, i.e. the rate of processing of at least a portion of received content for a given telecommunications technology, although the invention is not limited in this regard. Degradation in throughput may occur if the size of received content exceeds a given capacity of a single contiguous location within at least a single memory channel of memory 106, possibly due to memory access latency.

According to an example embodiment, the distributing of portions of received content across at least one memory channel of memory 106 may lessen the utilization of a single contiguous location within at least a single memory channel of memory 106.

In an example implementation, a lessening in the utilization of a single contiguous location within at least a single memory channel of memory 106 may reduce the queuing of memory channel read and write requests to that single contiguous location. The reduction in queuing may also reduce memory access latency and thus allow a given throughput to be met, although the invention is not limited in this regard.

Agent(s) 112 represent elements of system 100 which may request access to at least a portion of received content distributed across at least one memory channel of memory 106. As used herein, agent(s) 112 is intended to represent any of a number of hardware and/or software element(s) to request and receive access to at least a portion of received content distributed across at least one memory channel of memory 106 or one or more other forms of memory communicatively coupled to system 100 (not particularly denoted). In this regard, according to one example implementation, agent(s) 112 may well comprise one or more of a software application, a hardware device driver, a microprocessor, and the like.

In an example embodiment, agent(s) 112 may request access to at least portions of received content, which may have been distributed across at least one memory channel of memory 106. Requests for access may be handled through one or more access manager(s) 116.

According to one example implementation, to fulfill this access request, access manager(s) 116 may simultaneously read the distributed portions of received content, combine the distributed portions of received content as if the portions of received content were distributed to a single contiguous location within at least one memory channel of memory 106, and may then present the portions of received content to agent(s) 112.

Since agent(s) 112 is presented with the at least portions of received content as if stored in a single memory channel of memory 106, memory access latency may be reduced, at least in part, by agent(s) 112 only making read requests to a single contiguous location within at least one memory channel of memory 106, rather then a plurality of non-contiguous locations of at least one memory channel of memory 106. Thus, since memory access latency is reduced, a given throughput may be more likely met, although the invention is not limited in this regard.

As used herein, routing manager(s) 114 and/or access manager(s) 116 may well be implemented in one or more of a number of hardware and/or software element(s). In this regard, according to one example implementation, routing manager(s) 114 and/or access manager(s) 116 may well comprise, one or more of a memory controller, cache controller, embedded logic, or the like.

It should be appreciated that routing manager(s) 114 and/or access manager(s) 116 need not be integrated within electronic system 100 for electronic system 100 to access and benefit from the features of routing manager(s) 114 and/or access manager(s) 116 described herein. That is, I/O interfaces 108 may provide a communications interface between routing manager(s) 114 and/or access manager(s) 116 and an electronic system through, e.g., a network communication channel. Thus, enabling the remote electronic system to access and employ the features of routing manager(s) 114 and/or access manager(s) 116.

I/O interfaces 108 may also enable one or more element(s), e.g., control logic 102 to interact with input and/or output devices. For example, input devices such as a mouse, keyboard, touchpad, etc. and/or output devices (e.g., cathode ray tube monitor, liquid crystal display, etc.).

Mass storage 110 is intended to represent any of a number of storage media known in the art including, but not limited to, for example, a magnetic disk or optical disc and its corresponding drive, a memory card, or another device capable of storing machine-readable instructions.

According to one example embodiment, the determination of whether to distribute at least a portion of received content across at least one memory channel to meet a given throughput by routing manager(s) 114 as well as accessing and presenting the received content by access manager(s) 116, may well be implemented in hardware, software, firmware, or any combination thereof e.g., coupled to system 100, as shown. In this regard, routing manager(s) 114 and/or access manager(s) 116 may well be implemented as one or more of an Application Specific Integrated Circuit (ASIC), a special function controller or processor, a Field Programmable Gate Array (FPGA), or other hardware device, firmware or software to perform at least the functions described herein.

Although shown as a number of disparate functional elements, those skilled in the art will appreciate from the disclosure herein, that memory controllers and/or page managers of greater or lesser complexity that nonetheless perform the functions/features described herein, whether implemented in hardware, software, firmware or a combination thereof, are anticipated within the scope and spirit of the present invention.

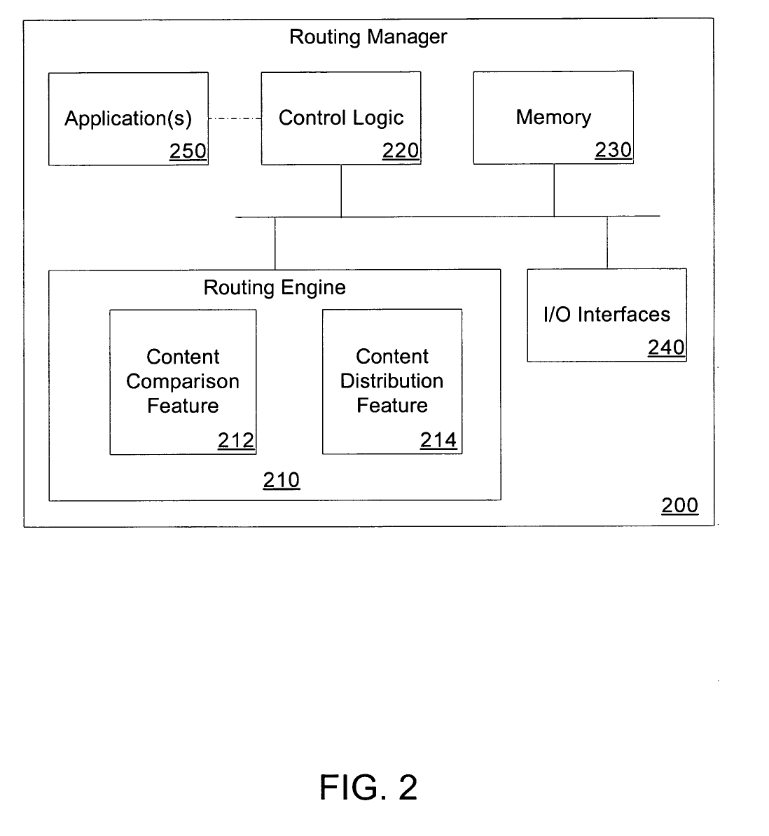

FIG. 2 is an architectural diagram of a routing manager, according to one example embodiment of the present invention. In accordance with the illustrated example implementation of FIG. 2, routing manager 200 is depicted comprising one or more of a routing engine 210, control logic 220, memory 230, I/O interfaces 240, and optionally, one or more application(s) 250, each coupled as depicted.

In accordance with one example embodiment of the present invention, routing engine 210 is depicted comprising one or more of a content comparison feature 212 and content distribution feature 214. As introduced above, and developed more fully below, content comparison feature 212 and content distribution feature 214 of routing engine 210 compare the size of at least a portion of content received by electronic system 100 to the capacity of a single contiguous location within at least one memory channel of memory 106 to meet a given throughput and determine whether to distribute at least a portion of received content across at least one memory channel of memory 106 based, at least in part, on the comparison.

As used herein, control logic 220 may control the overall operation of routing manager 200 and is intended to represent any of a wide variety of logic device(s) and/or executable content to implement the operation of routing manager 200, described herein. In this regard, control logic 220 may well be comprised of a microprocessor, microcontroller, field-programmable gate array (FPGA), application specific integrated circuit (ASIC), executable content to implement such control features and/or any combination thereof. In alternate embodiments, the features and functionality of control logic 220 may well be implemented within routing engine 210.

According to one example embodiment, control logic 220 may selectively invoke an instance of routing engine 210 to compare the size of at least a portion of content received by electronic system 100 to the capacity of a single contiguous location within at least one memory channel of memory 106 and determine whether to distribute at least a portion of received content across the at least one memory channel of memory 106 based, at least in part, on the comparison. Distribution of at least a portion of received content may be based, at least in part, on whether at least a portion of received content exceeds a capacity of a single contiguous location within the at least one memory channel of memory 106 to meet a given throughput.

As used herein, memory 230 is similarly intended to represent a wide variety of memory media including, but not limited to, volatile memory, non-volatile memory, flash and programmatic variables or states. According to an example implementation, memory 230 is used by routing engine 210 to temporarily store a received content size comparison table, e.g., generated by content comparison feature 212. In this regard, memory 230 may well include a received content size comparison table with one or more entries for placing comparison values generated by content comparison feature 212 and associated with the capacity of a single contiguous location within at least one memory channel of memory 106 to meet a given throughput.

According to example implementation, memory 230 may also be used to store executable content. The executable content may be used by control logic 220 to selectively execute at least a subset of the executable content to implement an instance of routing engine 210 to compare and determine whether to distribute at least a portion of received content across at least one memory channel of memory 106.

As used herein, I/O interfaces 240 provide a communications interface between routing manager 200 and an electronic system. For example, routing manager 200 may be implemented as an element of a computer system, wherein I/O interfaces 240 provide a communications interface between routing manager 200 and the computer system via a communication channel. In this regard, control logic 220 can receive a series of instructions from application software external to routing manager 200 via I/O interfaces 240.

In an example embodiment, routing manager 200 may include one or more application(s) 250 to provide internal instructions to control logic 220. As used herein, such application(s) 250 may well be invoked to generate a user interface, e.g., a graphical user interface (GUI), to enable administrative features, and the like. In alternate embodiments, one or more features of routing engine 210 may well be implemented as an application(s) 250, selectively invoked by control logic 220 to invoke such features. To the extent that they are not used to implement one or more features of the present invention application(s) 250 are not necessary to the function of routing manager 200.

According to one example embodiment, content in the form of a data packet is received by electronic system 100. As introduced above, the data packet may include packet meta data. Routing agent 200 compares the size of the packet meta data to the capacity of a single contiguous location within at least one memory channel of memory 106 to meet a given throughput and determines whether to distribute the packet meta data across at least one memory channel of memory 106 based, at least in part on the comparison. In this regard, routing agent 200 selectively invokes an instance of content comparison feature 212 to populate a temporary received content size comparison table, e.g. maintained in memory 230, with the single contiguous location capacities of at least one memory channel of memory 106 to meet a given throughput, i.e. the rate of processing of at least a portion of received content for a given communication channel speed.

Content comparison feature 212 then compares the size of the packet meta data to the capacities listed in the temporary received content size comparison table and generates a comparison result. Content distribution feature 214 then determines whether to distribute the packet meta data across the at least one memory channel of memory 106 based at least in part on the comparison result generated by content comparison feature 212. If for example, the comparison result indicates that the size of the packet meta data exceeds the capacity of a single contiguous location within the at least one memory channel of memory 106 to meet a given throughput, content distribution feature 212 may distribute the packet meta data across the at least one memory channel of memory 106 to meet the given throughput.

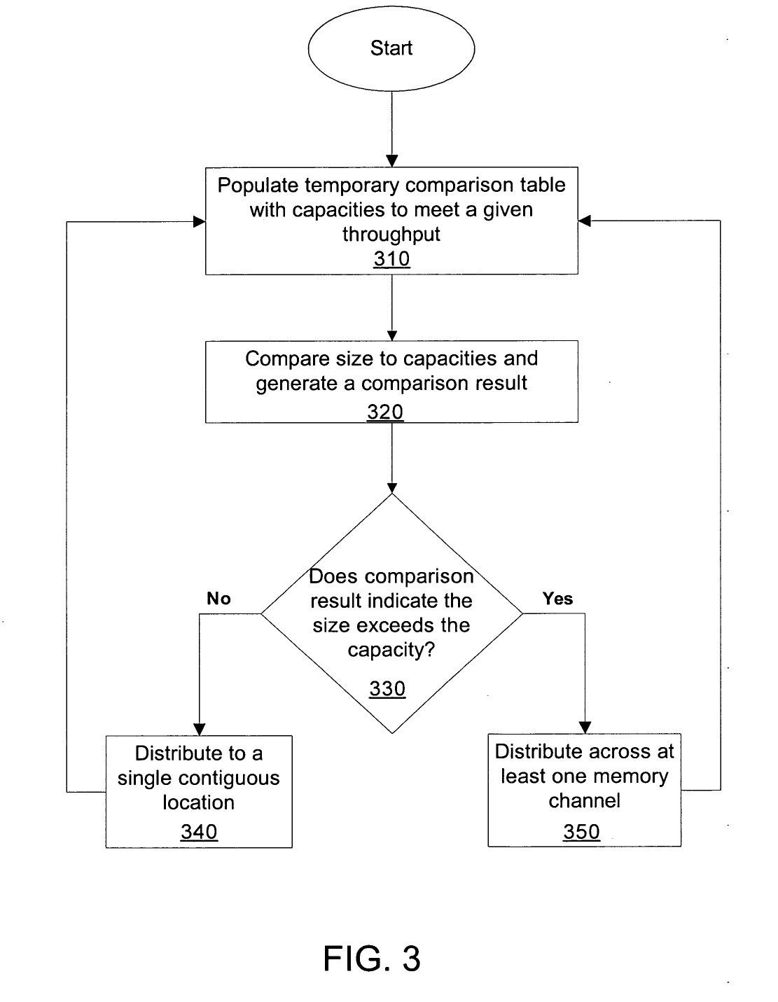

FIG. 3 is a flow chart of an example method of meeting a given content throughput in accordance with the teachings of the present invention, according to one example embodiment. In the illustrated embodiment of FIG. 3, the process begins with block 310 wherein routing engine 210 selectively invokes an instance of content comparison feature 212 to populate a temporary received content size comparison table with the single contiguous location capacities for at least a single memory channel of memory 106 to meet a given throughput.

Once the temporary received content size comparison table is populated, the process moves to block 320 wherein content comparison feature 212 compares the size of at least a portion of received content to the capacities listed in the temporary received content size comparison table and generates a comparison result.

Once the comparison result is generated by content comparison feature 212, the process moves to block 330 wherein routing engine 210 selectively invokes an instance of content distribution feature 214. Content distribution feature 214 determines whether the comparison result, generated by content comparison feature 212, indicates that the size of at least a portion of received content exceeds the capacity of a single contiguous location within the at least one memory channel of memory 106 to meet a given throughput.

If the comparison result indicates that the size of at least a portion of received content does not exceed the capacity of a single contiguous location within the at least one memory channel of memory 106 to meet a given throughput, the process continues with block 340, wherein content distribution feature 214 distributes at least a portion of received content across a single contiguous location within the at least one memory channel of memory 106 to meet the given throughput. The process then returns to block 310.

If the comparison result indicates that the size of the received content exceeds the capacity of a single contiguous location within the at least one memory channel of memory 106 to meet a given throughput, the process continues with block 350, wherein content distribution feature 214 distributes at least a portion of received content across the at least one memory channel of memory 106 to meet the given throughput. The process then returns to block 310.

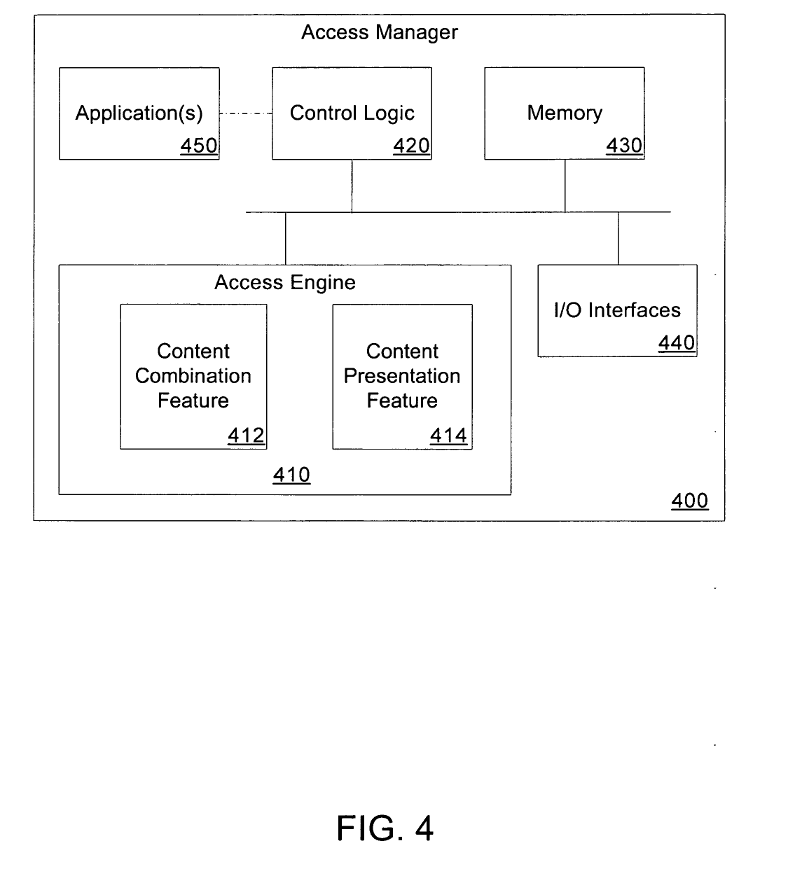

FIG. 4 is an architectural diagram of an access manager, according to one example embodiment of the present invention. In accordance with the illustrated example implementation of FIG. 4, access manager 400 is depicted comprising one or more of an access engine 410, control logic 420, memory 430, I/O interfaces 440, and optionally, one or more application(s) 450, each coupled as depicted.

In accordance with one example embodiment of the present invention, access engine 410 is depicted comprising one or more of a content combination feature 412 and content presentation feature 414. As introduced above, and developed more fully below, content combination feature 412 and content presentation feature 414 of access engine 410 access at least a portion of received content distributed across at least one memory channel of memory 106, wherein at least a portion of received content is read simultaneously across the at least one memory channel of memory 106, combined as if distributed to a single contiguous location within the at least one memory channel of memory 106 and presented to agent(s) 112.

As used herein, control logic 420 may control the overall operation of access manager 400 and is intended to represent any of a wide variety of logic device(s) and/or instructions which coordinates the overall operation of access manager 400. In this regard, control logic 420 may well be comprised of a microprocessor, microcontroller, field-programmable gate array (FPGA), application specific integrated circuit (ASIC), executable instructions to implement such control features and/or any combination thereof. In alternate embodiments, the features and functionality of control logic 420 may well be implemented within access engine 410.

According to one example embodiment, control logic 420 may selectively invoke an instance of access engine 410 to access at least a portion of received content, possibly distributed across at least one memory channel of memory 106, wherein at least a portion of received content may be read simultaneously across the at least one memory channel of memory 106, combined as if at least a portion of received content was distributed to a single contiguous location within the at least one memory channel of memory 106, and presented to agent(s) 112.

As used herein, memory 430 is similarly intended to represent a wide variety of memory media including, but not limited to, volatile memory, non-volatile memory, flash and programmatic variables or states.

According to an example implementation, memory 430 is used by access engine 410 to temporarily store the combined received content, e.g., generated by content combination feature 412.

According to example implementation, memory 430 may also be used to store executable instructions. The instructions may be used by control logic 420 to selectively execute at least a subset of the executable instructions to implement an instance of access engine 410 to access, combine and present at least a portion of received content distributed across at least one memory channel of memory 106.

As used herein, I/O interfaces 440 provide a communications interface between access manager 400 and an electronic system. For example, access manager 400 may be implemented as an element of a computer system, wherein I/O interfaces 440 provide a communications interface between access manager 400 and the computer system via a communication channel. In this regard, control logic 420 can receive a series of instructions from application software external to accessing manger 400 via I/O interfaces 440.

It should be appreciated that access manager 400 need not be integrated within an electronic system for the electronic system to access and benefit from the features of access manager 400 described herein. That is, as introduced above, I/O interfaces 440 may provide a communications interface between access manager 400 and an electronic system through, e.g., a network communication channel, enabling the remote electronic system to access and employ the features of access manager 400.

In an example embodiment, access manager 400 may include one or more application(s) 450 to provide internal instructions to control logic 420. As used herein, such application(s) 450 may well be invoked to generate a user interface, e.g., a graphical user interface (GUI), to enable administrative features, and the like. In alternate embodiments, one or more features of access engine 410 may well be implemented as an application(s) 450, selectively invoked by control logic 420 to invoke such features. To the extent that they are not used to implement one or more features of the present invention application(s) 450 are not necessary to the function of access manager 400.

In accordance with one example implementation, access manager 400 receives a request for access to at least a portion of received content distributed across at least one memory channel of memory 106, e.g. from agent(s) 112. In response to control logic 420, access engine 410 selectively invokes an instance of content combination feature 412 to access at least a portion of received content distributed across the at least one memory channel of memory 106.

In an example implementation, the at least portion of received content may be packet meta data. As introduced above, the packet meta data may also include a packet handle. A 1:1 mapping from a packet handle to each of the distributed packet meta data locations in at least one memory channel of memory 106, may allow for the accessing of portions of the packet meta data distributed across at least one memory channel of memory 106. Therefore, given a packet handle, the location of the packet meta data distributed across the at least one memory channel of memory 106 may be determined, although the invention is not limited in this regard.

In another example implementation, locations of memory 106 may be selectively allocated for packet meta data distributed across at least one memory channel of memory 106. Based at least in part on this allocation, the location of the packet meta data distributed across the at least one memory channel of memory 106 may be determined, although the invention is not limited in this regard.

In an example implementation, based at least in part on the 1:1 mapping from the packet handle or to the selective allocation of locations for each of the packet meta data locations distributed across at least one memory channel of memory 106, content combination feature 412 may access the distributed packet meta data and may read the distributed packet meta data simultaneously across the at least one memory channel of memory 106. Content combination feature 412 may then combine the distributed packet meta data as if the packet meta data were distributed to a single contiguous location within the at least one memory channel of memory 106 and temporarily store the recombined packet meta data in memory 430.

Access engine 410 then may invoke an instance of content presentation feature 414 to retrieve the recombined packet meta data, temporarily stored by content combination feature 412 in memory 430, and present the recombined packet meta data to agent(s) 112 as a cohesive self-contained unit.

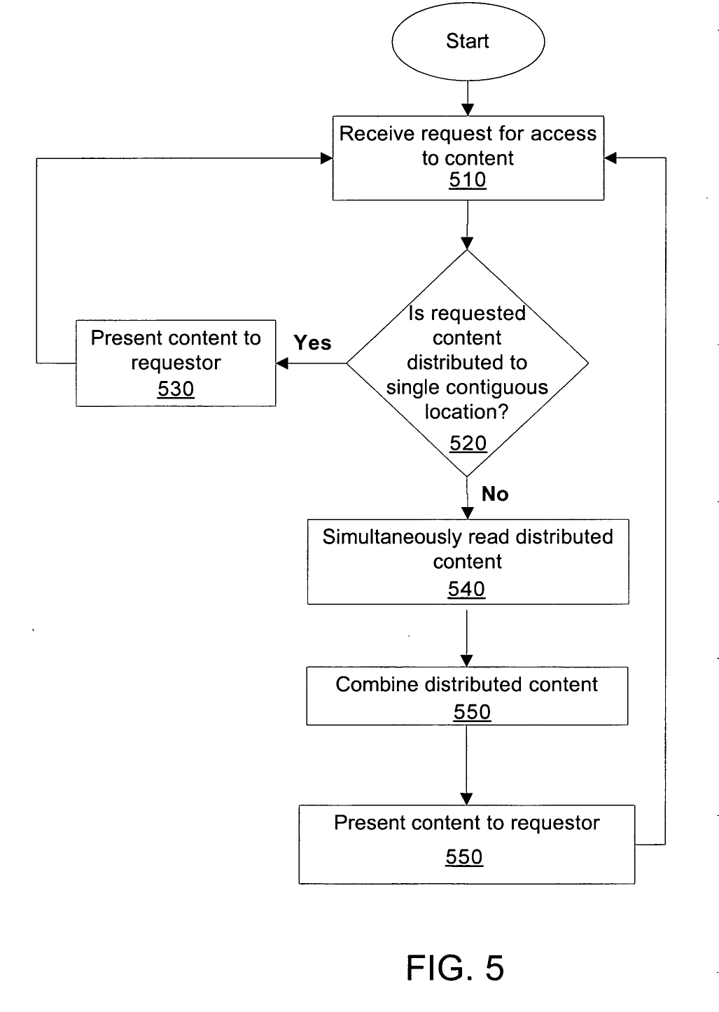

FIG. 5 is a flow chart of an example method of accessing at least a portion of received content distributed across at least one memory channel, combining, and presenting the at least a portion of received content, according to one example embodiment. In the illustrated embodiment of FIG. 5, the process begins with block 510 wherein access manager 400 receives a request, e.g. from agent(s) 112, for access to at least a portion of received content.

Once the request is received, the process moves to block 520 wherein control logic 420 invokes an instance of access engine 410. According to one example implementation, in response to control logic 420, access engine 410 selectively invokes an instance of content combination feature 412. Content combination feature 412 accesses the requested at least portion of received content, which may have been distributed across at least one memory channel of memory 106. If the requested at least portion of received content is distributed to a single contiguous location within the at least one memory channel of memory 106, the process moves to block 530.

In block 530, content combination feature 412 accesses the at least portion of received content distributed to a single contiguous location within the at least one memory channel of memory 106. According to one example implementation, in response to control logic 420, access engine 410 selectively invokes an instance of content presentation feature 414. Content presentation feature 414 presents the at least portion of received content accessed by content accessing feature 412 to the requestor and the process returns to block 510.

If the requested at least portion of received content is distributed across a plurality of non-contiguous locations of the at least one memory channel of memory 106, the process moves to block 540. In block 540, according to an example implementation, content combination feature 412 simultaneously reads the requested at least portion of received content across the at least one memory channel of memory 106. The process then moves to block 550.

In block 550, content combination feature 412 combines the at least portion of received content as if distributed to a single contiguous location within the at least one memory channel of memory 106. Content combination feature may then temporarily store the combined at least portion of received content in memory 430. The process then moves to block 560

In block 560, according to one example implementation, in response to control logic 420, access engine 410 selectively invokes an instance of content presentation feature 414. Content presentation feature 414 may retrieve the combined at least portion of received content temporarily stored by content combination feature 412 in memory 430 and present the combined at least portion of received content to agent(s) 112.

In an example implementation, the distributed at least portion of received content may be packet meta data. Once the distributed packet meta data is combined by content combination feature 412, content presentation feature 414 may present the combined packet meta data as if it were a cohesive self-contained unit located within a single contiguous location within at least one memory channel of memory 106. The process then returns to block 510.

In accordance with one example embodiment, machine-readable instructions can be provided to memory 106 from a form of machine-accessible medium. As used herein, a machine-accessible medium is intended to represent any mechanism that provides (i.e., stores and/or transmits) information in a form readable by a machine (e.g., a electronic system 100). For example, a machine-accessible medium may well include read only memory (ROM); random access memory (RAM); magnetic disk storage media; optical storage media; flash memory devices; electrical, optical, acoustical or other form of propagated signals (e.g., carrier waves, infrared signals, digital signals); and the like. Instructions may also be provided to memory 106 via a remote connection (e.g., over a network).

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative of, rather than limiting the scope and coverage of the claims appended hereto.

1. A method comprising:
comparing the size of at least a portion of received content to a capacity of a single contiguous location within at least one memory channel to meet a given throughput; and
determining whether to distribute the at least portion of received content across the at least one memory channel based, at least in part, on the comparison.

2. A method according to claim 1, wherein the at least portion of received content is distributed across a plurality of non-contiguous locations within the at least one memory channel if the at least portion of received content exceeds the capacity of a single contiguous location within the at least one memory channel to meet a given throughput.

3. A method according to claim 1, wherein the at least portion of received content is a packet meta data.

4. A method according to claim 2, wherein the capacity of the single contiguous location within the at least one memory channel to meet the given throughput is less than 32 bytes.

5. A method according to claim 4, wherein a memory size of the packet meta data is at least 32 bytes.

6. A method according to claim 5, wherein the determination to distribute across a plurality of non-contiguous locations within the at least one memory channel is based, at least in part, on whether the packet meta data can be distributed in a way to meet the given throughput.

7. A method according to claim 1, wherein the given throughput is communication channel speed.

8. A method according to claim 1, wherein the method is implemented in a network processor.

9. A method according to claim 1, wherein the determining whether to distribute occurs at start-up.

10. A method comprising:
accessing at least a portion of received content distributed across at least one memory channel, wherein the at least portion of received content is read simultaneously across the at least one memory channel; and
combining the at least portion of received content as if the at least portion of received content were distributed to a single contiguous location within the at least one memory channel.

11. A method according to claim 10, further comprising:
presenting the at least portion of received content to an agent.

12. A method according to claim 11, wherein the at least portion of received content is a packet meta data.

13. A method according to claim 12, wherein the packet meta data includes a packet handle.

14. A method according to claim 13, wherein the packet handle is 1:1 mapped to the packet meta data distributed across the at least one memory channel to facilitate the accessing of the packet meta data distributed across the at least one memory channel.

15. A method according to claim 14, wherein combining the packet meta data distributed across the at least one memory channel is accomplished by temporarily storing the recombined packet meta data in local memory.

16. A method according to claim 15, wherein presenting the packet meta data is accomplished by making the recombined packet meta data, temporarily stored in local memory, available to an agent as if it were a cohesive self-contained unit.

17. A method according to claim 11, wherein the method is implemented in a network processor.

18. An apparatus comprising:
a memory, including at least one memory channel; and
a routing manager, communicatively coupled with the memory, to distribute at least a portion of received content to the at least one memory channel to meet a given throughput.

19. An apparatus according to claim 18, wherein the routing manager distributes the at least portion of received content by storing the at least portion of received content in a plurality of non-contiguous locations within the at least one memory channel.

20. An apparatus according to claim 18, the apparatus further comprising:
a memory to store content, at least a subset of which is executable content; and
a control logic, communicatively coupled with the memory, to selectively execute at least a subset of the executable content, to implement an instance of the routing manager.

21. An apparatus according to claim 20, wherein the control logic is implemented in a network processor.

22. An apparatus according to claim 18, wherein the memory is static random access memory.

23. An apparatus comprising:
a memory, including at least one memory channel; and
an access manager, communicatively coupled with the memory, to read at least a portion of received content from the at least one memory channel and to combine the at least portion of received content as if the at least portion of received content were distributed to a single contiguous location within at least one memory channel.

24. An apparatus according to claim 23 wherein the access manager presents the combined at least portion of received content to an agent.

25. An apparatus according to claim 23 wherein the at least portion of received content is packet meta data which includes a packet handle, the packet handle 1:1 mapped to the packet meta data.

26. An apparatus according to claim 25 wherein the access manager uses the packet handle to locate and read the packet meta data from the at least one memory channel.

27. An apparatus according to claim 23, the apparatus further comprising:
a memory to store content, at least a subset of which is executable content; and
a control logic, communicatively coupled with the memory, to selectively execute at least a subset of the executable content, to implement an instance of the access manager.

28. An apparatus according to claim 23, wherein the control logic is implemented in a network processor.

29. An apparatus according to claim 23, wherein the memory is static random access memory.

30. A system comprising:
a memory, including at least one memory channel; and
a routing manager, coupled with the memory to selectively distribute at least a portion of received content to the at least one memory channel based, at least in part, on whether the at least portion of received content exceeds a capacity of a single contiguous location within the at least one memory channel to meet a given throughput.

31. A system according to claim 30, wherein the routing manager distributes the at least portion of received content by storing the at least portion of received content in a plurality of non-contiguous locations within the at least one memory channel.

32. A system according to claim 30, wherein the capacity of a single contiguous location within the at least a single memory channel is less than 32 bytes.

33. A system according to claim 30, wherein the routing manager is implemented in a network processor.

34. A system according to claim 30, wherein the memory is static random access memory.

35. A storage medium comprising content, which, when executed by a machine, causes the machine to:
compare the size of at least a portion of received content to a capacity of a single contiguous location within at least one memory channel to meet a given throughput; and
determine whether to distribute the at least portion of received content across the at least one memory channel, based at least in part, on the comparison.

36. A storage medium according to claim 35, wherein the at least portion of received content is distributed across a plurality of non-contiguous locations within the at least one memory channel if the at least portion of received content exceeds the capacity of a single contiguous location within the at least one memory channel to meet a given throughput.

37. A storage medium according to claim 36, wherein the at least portion of received content is packet meta data.

38. A storage medium according to claim 37, wherein the capacity of the single contiguous location within the at least one memory channel to meet the given throughput is less than 32 bytes.

39. A storage medium according to claim 38, wherein a memory size of the packet meta data is at least 32 bytes.

40. A storage medium according to claim 39, wherein the determination to distribute across a plurality of non-contiguous locations within the at least one memory channel is based, at least in part, on whether the packet meta data can be distributed in a way to meet the given throughput.

41. A storage medium according to claim 35, wherein the given throughput is communication channel speed.

42. A storage medium comprising content, which, when executed by a machine, causes the machine to:
access at least a portion of received content distributed across at least one memory channel, wherein the at least portion of received content is read simultaneously across the at least one memory channel; and
combine the at least portion of received content, as if the at least portion of received content was distributed to a single contiguous location within the at least one memory channel.

43. A storage medium according to claim 42, further comprising:
presenting the at least portion of received content to an agent.

44. A storage medium according to claim 43, wherein the at least portion of received content is a packet meta data

45. A storage medium according to claim 44, wherein the packet meta data includes a packet handle.

46. A storage medium according to claim 45, wherein the packet handle is 1:1 mapped to the packet meta data distributed across the at least one memory channel to facilitate the accessing of the packet meta data distributed across the at least one memory channel.

47. A storage medium according to claim 46, wherein combining the packet meta data distributed across the at least one memory channel is accomplished by temporarily storing the recombined packet meta data in local memory.

48. A storage medium according to claim 47, wherein presenting the packet meta data is accomplished by making the recombined packet meta data, temporarily stored in local memory, available to an agent as a cohesive self-contained unit.
